(19) United States
(12) Patent Application Publication
(10) Pub. No.: US 2013/0206568 A1
(43) Pub. Date: Aug. 15, 2013

(54) TOUCH PANEL

(71) Applicants: Yu-Hua Wu, Taoyuan County (TW); Cheng-Yi Chou, Yunlin County (TW); Chih-Yuan Wang, Taichung City (TW); Ting-Yu Chang, Kaohsiung City (TW); Ching-Fu Hsu, Taichung City (TW); Hsiao-Hui Liao, Taichung City (TW)

(72) Inventors: Yu-Hua Wu, Taoyuan County (TW); Cheng-Yi Chou, Yunlin County (TW); Chih-Yuan Wang, Taichung City (TW); Ting-Yu Chang, Kaohsiung City (TW); Ching-Fu Hsu, Taichung City (TW); Hsiao-Hui Liao, Taichung City (TW)

(73) Assignees: WINTEK CORPORATION, Taichung City (TW); Dongguan Masstop Liquid Crystal Display Co., Ltd., Guangdong Province (CN)

(21) Appl. No.: 13/759,040

(22) Filed: Feb. 5, 2013

(30) Foreign Application Priority Data
Feb. 14, 2012 (TW) 101104628

(51) Int. Cl. H01H 13/10

(52) U.S. Cl. CPC H01H 13/10
USPC 200/600

(57) ABSTRACT

A touch panel including a first substrate, a second substrate, a first sensing layer, a second sensing layer, and a plurality of spacers is provided. The second substrate is parallel to and opposite to the first substrate in a top-bottom manner. The first sensing layer is disposed on the first substrate and located between the first substrate and the second substrate. The second sensing layer is disposed on the second substrate. The spacers are located between the first sensing layer and the second sensing layer, and the spacers includes a plurality of movable first spacers and a plurality of second spacers fixed on the second substrate, wherein each of the first spacers is surrounded by a portion of the second spacers.

### CROSS-REFERENCE TO RELATED APPLICATION

This application claims the priority benefit of Taiwan application Ser. No. 101104628, filed on Feb. 14, 2012. The entirety of the above-mentioned patent application is hereby incorporated by reference herein and made a part of this specification.

### BACKGROUND OF THE INVENTION

1. Field of the Invention

The invention relates to a panel. More particularly, the invention relates to a touch panel.

2. Description of Related Art

At present, the touch panels can be generally classified into capacitive, resistive, optical, acoustic, and electromagnetic touch panels, wherein the resistive touch panels and the capacitive touch panels are most popular. Generally, a user can press the resistive touch panel through an object such as an insulating pen and the resistive touch panel detects the touch position of the object through the voltage change generated in the resistive touch panel in response to the pressing of the object. On the other hand, a user can press the capacitive touch panel through a naked finger or a conductive object and the capacitive touch panel detects the touch position of the naked finger or the conductive object through the capacitance change generated in the capacitive touch panel in response to the coupling of the naked finger or the conductive object.

A further improved technology achieves the capacitive touch panel capable of sensing the touch of an insulating pen. Specifically, sensing structures such as a plurality of sensing layers are disposed on different substrates for constructing a capacitive touch panel. The capacitance between the sensing layers can be changed in response to the bending of the substrate owing that a user presses the capacitive touch panel through an insulating pen. Based on such mechanism, the touch position of the insulating pen can be detected by the capacitive touch panel. Accordingly, a user can operate the capacitive touch panel through an insulating pen or insulating materials in addition to the naked finger or the conductive object. However, resulting from the material of the substrate, the substrate may not rapidly revert back to the original planar state after being pressed so that the time extension of the touch sensing signal or the erroneous detection is generated.

### SUMMARY OF THE INVENTION

The invention provides a touch panel having a favorable capability of restoring from deformation.

The invention provides a touch panel including a first substrate, a second substrate, a first sensing layer, a second sensing layer, and a plurality of spacers. The second substrate is parallel to and opposite to the first substrate in a top-bottom manner. The first sensing layer is disposed on the first substrate and located between the first substrate and the second substrate. The second sensing layer is disposed on the second substrate. The spacers are located between the first sensing layer and the second sensing layer, and the spacers includes a plurality of movable first spacers and a plurality of second spacers fixed on the second substrate, wherein each of the first spacers is surrounded by a portion of the second spacers.

According to an embodiment of the invention, in the touch panel, a moving distance of each of the first spacers is not greater than a diameter of each of the first spacers.

According to an embodiment of the invention, in the touch panel, at least one first spacer leans between the first substrate and the second substrate.

According to an embodiment of the invention, the diameters of the first spacers are greater than the diameters of the second spacers.

According to an embodiment of the invention, the second spacers form a plurality of patterns arranged regularly on the second substrate.

According to an embodiment of the invention, the touch panel further includes a medium filled between the first substrate and the second substrate.

According to an embodiment of the invention, the touch panel further includes a sealant and at least one third spacer disposed inside the sealant. The sealant connects the first substrate and the second substrate. The at least one third spacer is leant between the first substrate and the second substrate and the diameters of the first spacers are not greater than the diameter of the at least one third spacer.

According to an embodiment of the invention, the touch panel further includes a decoration layer located at the periphery of the first sensing layer.

According to an embodiment of the invention, the first sensing layer is a single-layered sensing electrode.

According to an embodiment of the invention, the second sensing layer is located between the first substrate and the second substrate.

According to an embodiment of the invention, the second sensing layer is located a side of the second substrate away from the first substrate.

In view of the above, the first spacers located between the first sensing layer and the second sensing layer is restricted by the second spacers fixed on the second substrate in the touch panel according to the invention. After removing the pressure on the first substrate, the movable first spacers are rapidly rebounded toward the original position so that the erroneous detection owing that the deformation of the first substrate is not easily restored is prevented and the touch sensitivity of the touch panel can be improved.

In order to make the aforementioned features and advantages of the invention more comprehensible, embodiments accompanying figures are described in detail below.

### BRIEF DESCRIPTION OF THE DRAWINGS

The accompanying drawings constituting a part of this specification are incorporated herein to provide a further understanding of the invention. Here, the drawings illustrate embodiments of the invention and, together with the description, serve to explain the principles of the invention.

FIG. 1 is a schematic cross-sectional view illustrating a touch panel according to an embodiment of the invention.

FIG. 2A is a schematic top view illustrating the first sensing layer of the touch panel depicted in FIG. 1.

FIG. 2B is a cross-sectional schematic view along line A-A′ in FIG. 2A.

FIG. 3 and FIG. 4 are schematic views of sensing electrodes according to other embodiments of the invention.

FIG. 5A and FIG. 5B schematically show the touch panel being touched by a touch object.

FIG. 6 through FIG. 9 schematically show the arrangement of the second spacers on the second substrate.

### DESCRIPTION OF EMBODIMENTS

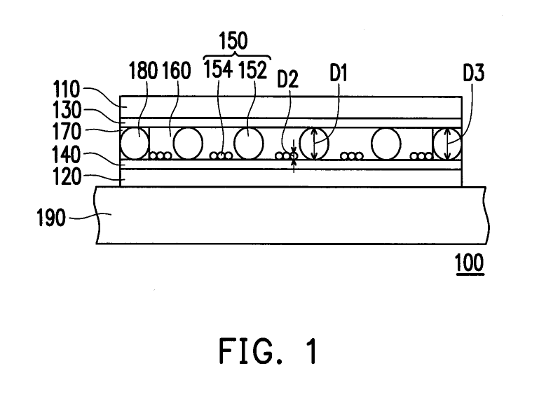

FIG. 1 is a schematic cross-sectional view illustrating a touch panel according to an embodiment of the invention.

Referring to FIG. 1, a touch panel 100 includes a first substrate 110, a second substrate 120, a first sensing layer 130, a second sensing layer 140, and a plurality of spacers 150.

The second substrate 120 is parallel to and opposite to the first substrate 110 in a top-bottom manner.

The first sensing layer 130 is disposed on the first substrate 110 and located between the first substrate 110 and the second substrate 120. The second sensing layer 140 is disposed on the second substrate 120. According to the present embodiment, the second sensing layer 140 is located between the first substrate 110 and the second substrate 120, which should not be construed as a limitation to the invention. In other embodiments, the second sensing layer 140 can be selectively located at a side of the second substrate 120 away from the first substrate 110. The spacers 150 are located between the first sensing layer 130 and the second sensing layer 140, and the spacers 150 includes a plurality of movable first spacers 152 and a plurality of second spacers 154 fixed on the second substrate 120, wherein each of the first spacers 152 is surrounded by a portion of the second spacers 154.

The diameters D1 of the first spacers 152 can be identical or different, preferably identical, and the diameters D2 of the second spacers 154 can be identical or the same. The diameters D1 of the first spacers 152 are greater than the diameters D2 of the second spacers 154 and the first spacers 152 are substantially leant between the first substrate 110 and the second substrate 120. In the present embodiment, the diameter D1 of the first spacers 150 can be two to four times of the diameters D2 of the second spacers 154, which should not be construed as a limitation to the invention.

Moreover, the touch panel 100 can further include a medium 160 filled between the first substrate 110 and the second substrate. Herein, the medium 160 can be the medium having high transparency such as silicone oil, liquid crystals, air, and preferably be the liquid material such as silicone oil and liquid crystals. Moreover, the touch panel 100 can further include a sealant 170 and a third spacer 180. The sealant 170 is used for connecting the first substrate 110 and the second substrate 120 together and the third spacer 180 is disposed inside the sealant 170 and leant between the first substrate 110 and the second substrate 120, wherein the diameters D1 of the first spacers 150 are not greater than the diameter D3 of the third spacer 180.

Moreover, the touch panel 100 can further include a supporting plate 190 and the second substrate 120 is disposed on the supporting plate 190. According to the present embodiment, the supporting plate 190 can be a liquid crystal display, an organic light emitting display, or other displays suitable for connected with the second substrate 120 of the touch panel 100. It is noted that the supporting plate 190 can be glass plate, plastic plate, or the like having rigid mechanical property. Whether the supporting plate 190 is disposed is determined on the rigidity of the first substrate 110 and the second substrate 120. In one instance, the supporting plate 190 can be omitted when the second substrate 120 is a rigid substrate. Alternately, the supporting plate 190 can be omitted when the second substrate 120 is served as the substrate of the display, which forms a combination of a touch panel and a display panel.

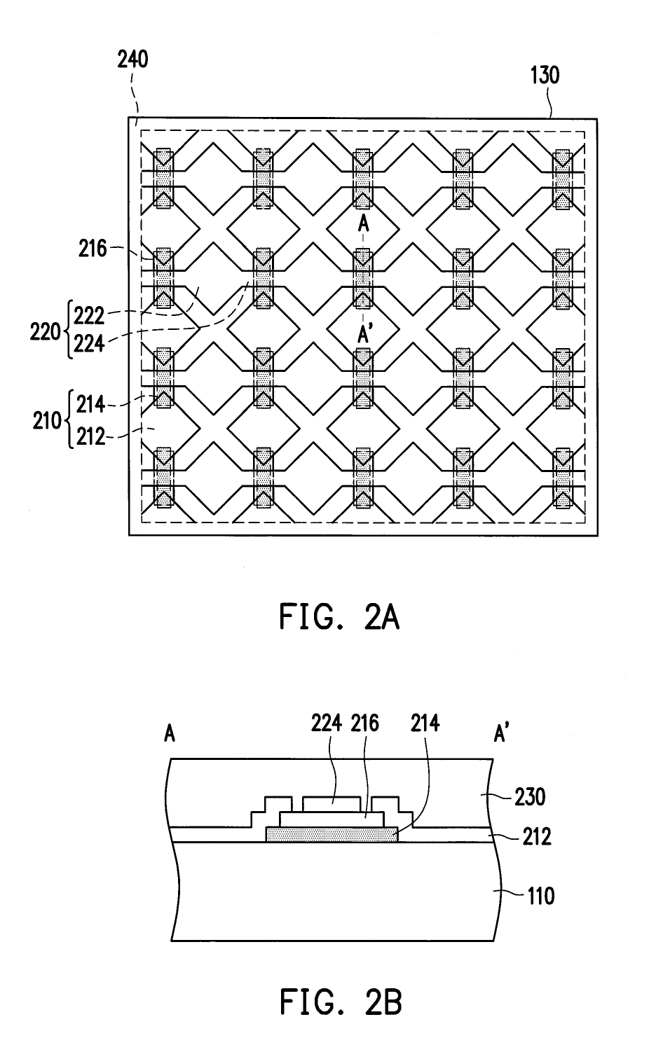

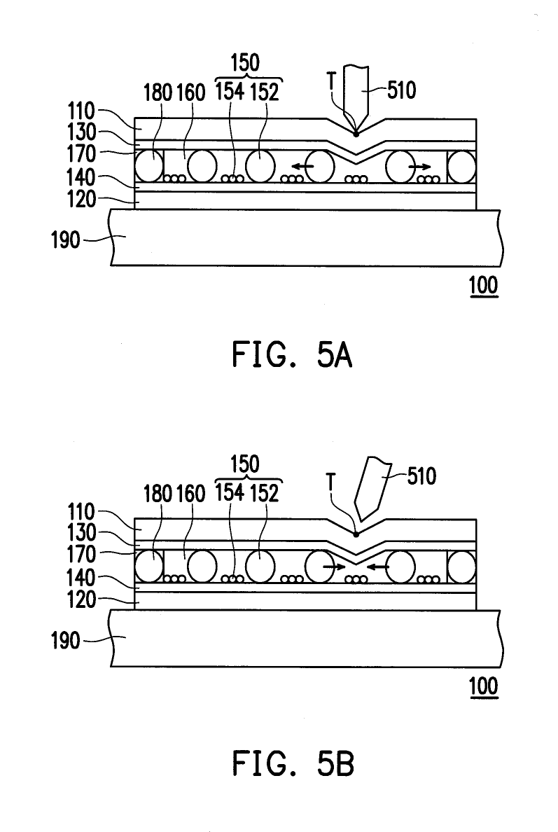

It is worthy to note that the touch panel 100 according to the present embodiment can have the capacitive touch sensing function capable of being operated through a user's naked finger or a conductive object and the pressing touch sensing function capable of being operated through the pressing of the touch object. The design of the first sensing layer 130 is described in FIG. 2A and FIG. 2B and the pressing sensing function of the touch object is illustrated in FIG. 5A and FIG. 5B. FIG. 2A is a schematic top view illustrating the first sensing layer of the touch panel depicted in FIG. 1. FIG. 2B is a cross-sectional schematic view along line A-A′ in FIG. 2A.

Referring to FIG. 2A and FIG. 2B, the first sensing layer 130, for example, includes a plurality of first sensing electrodes 210, a plurality of second sensing electrodes 220, and a first insulation layer 230 covering the first sensing electrodes 210 and the second sensing electrodes 220, wherein the first sensing electrodes 210 and the second sensing electrodes 220 are arranged in an array for achieving a sensing surface (as shown in FIG. 2A.). In the present embodiment, a decoration layer 240 can further selectively disposed on the periphery of the first sensing layer 130 for shielding the peripheral wires located at the periphery.

Besides, the first sensing electrodes 210 include a plurality of first sensing pads 212 and a plurality of bridge portions 214, and the first sensing pads 212 are electrically connected through the bridge portions 214 in each first sensing electrode 210. Besides, the second sensing electrodes 220 include a plurality of second sensing pads 222 and a plurality of neck portions 224, and the second sensing pads 222 are electrically connected through the neck portions 224 in each second sensing electrode 220.

As shown in FIG. 2B, the first sensing pads 212 and the second sensing pads 222 are located on the same plane and the neck portions 224 of the second sensing electrodes 220 cross over the bridge portions 214 by a second insulation layer 216 separated therebetween. Herein, the first sensing pads 212 and the second sensing pads 222 can be fabricated by the same film layer after the fabrication of the second insulation layer 216. In the present embodiment, the second insulation layer 216 is formed by a plurality of island patterns each exposing the two terminals of each bridge portion 214. Nevertheless, in other embodiments, the second insulation layer 216 can have a continuous layer structure having a plurality of openings exposing the two terminals of each bridge portion 214 and substantially covering all over the first substrate 110. In addition, the first sensing electrodes 210 and the second sensing electrodes 220 can be formed by different film layers and respectively located in the upper side and the bottom side of the second insulation layer 214. Herein, the second insulation layer 216 can be a non-patterned layer without openings. In one embodiment, the first sensing electrodes 210 and the second sensing electrodes 220 can be respectively located at two opposite sides of the first substrate 110 and the second insulation layer 216 can be selectively omitted when the first sensing electrodes 210 and the second sensing electrodes are formed by different film layers.

Under the circumstance that the user does not touch the touch panel 100 through a naked finger or a conductive object, an initial capacitance is formed between the first sensing electrodes 210 and the second sensing electrodes 220. When the user touches the touch panel 100 through a naked finger or a conductive object, the initial capacitance can be changed and the change of the capacitance can be utilized for detecting the touch position that the user touches the touch panel 100. That is to say, the first sensing electrodes 130 individually performs the capacitive touch sensing function and the user is required to operate the touch panel 100 through the conductive objects such as the naked finger, the conductive element, or the capacitive stylus.

It is noted that the disposition of the first sensing layer 130 is not restricted to the above description which is merely taken for illustrating that the capacitive touch sensing function of the touch panel 100 can include the known capacitive touch sensing function. In addition to the configuration of first sensing electrodes 210 and the second sensing electrodes 220, the first sensing layer 130 in other embodiments can be constructed by stripe conductive patterns rather than the strings of the first sensing pads 212 or the second sensing pads 222. In other designs, the first sensing layer 130 can be a single layered sensing electrode in any manner and combined with the second sensing layer 140 which is transparent for achieving the required sensing function. Alternately, the second sensing layer 140 can be selectively patterned.

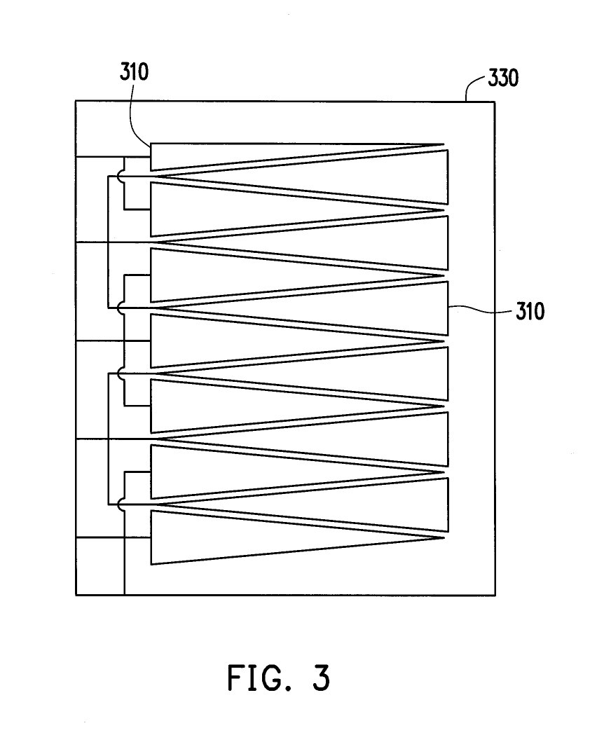

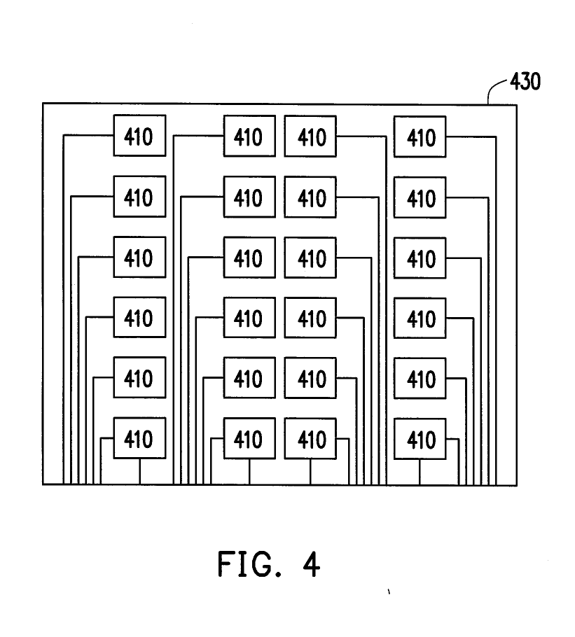

FIG. 3 and FIG. 4 are schematic views of sensing electrodes according to other embodiments of the invention. As shown in FIG. 3, the first sensing layer 330 can be a single layered sensing electrode having a plurality of triangle sensing electrodes 310 in the present embodiment. As shown in FIG. 4, the first sensing layer 430 can be a single layered sensing electrode having a plurality of rectangle sensing electrodes 410 in the present embodiment. As for the sensing electrodes 310 and 410 depicted in FIG. 3 and FIG. 4, the sensing electrodes 310 or 410 can be the same conductive pattern or different conductive patterns.

Specifically, the touch panel 100 according to the present embodiment has the touch sensing function capable of sensing the pressure change generated by the touch object in addition to sensing the capacitance change generated by the touch object as described in above, in which the touch sensing function capable of sensing the pressure change generated by the touch object is further depicted in FIG. 5A and FIG. 5B. FIG. 5A and FIG. 5B schematically show the touch panel being touched by a touch object.

Referring to FIG. 5A, the first substrate 110 is the plastic substrate or the glass substrate capable of deforming after pressing, i.e. the first substrate 110 is a flexible substrate. The first substrate 100 can be bended by subjecting to the stress when the user presses the first substrate 110 through the touch object 510 (which can be an insulation object or a conductive object). The capacitance between the first sensing layer 130 and the second sensing layer 140 can be changed according to the distance change therebetween, which can be utilized to detect the position the touch object pressing on the touch panel 100.

Generally, the medium 160 with high transparency such as the silicone oil or the liquid crystals is filled between the two substrates 110 and 120. The recovery of the first substrate 110 by the effect of the fluid such as the silicone oil and the liquid crystals is slow so that the time generating the touch signal can be extended or an erroneous detection can be generated after the user presses the first substrate 110 through the touch object 510. The spacers 150 are disposed within the medium 160 according to the touch panel 100 in the present embodiment, so that the recovery strength and the recovery rate of the first substrate 110 can be improved for enhancing the sensitivity of the touch panel 100 operated through the touch object 510.

In specific, the movable first spacers 152 can move away from the touch point T by subjecting to the pressure when the user presses the first substrate 110 through the touch object 510. Owing that the second spacers 154 fixed on the second substrate 120 surrounds the movable first spacers 152, the first spacers 152 would lean against the fixed second spacers 154 after moving a particular distance and can not move farther. Therefore, the moving distance of the first spacers 152 is restricted in the particular range. For instance, in the present embodiment, the movable distance of each first spacer 152 is not greater than the diameter D1 of each first spacer 152.

Next, referring to FIG. 5B, the first spacer 152 leant against the second spacers 154 and subjected to the pressure can be rapidly rebounded owing to a reaction force of the second spacers 154 and the action of the medium 160 after the touch object 510 is separated from the touch point T. Accordingly, the first substrate 110 can be restored to the original state (e.g. the planar and non-bended state) by the effect of the first spacers 152. Overall, the time extend of the touch signal and the erroneous detection owing that the substrate is not easily restored to the original planar state are prevented and the touch sensitivity of the touch sensing function capable of sensing the pressing operation of the touch object can be enhanced through enhancing the rebounding force of the first substrate 110 by configuring the spacers 150 and further through restricting the positions of the first spacers 152 by the second spacers 154.

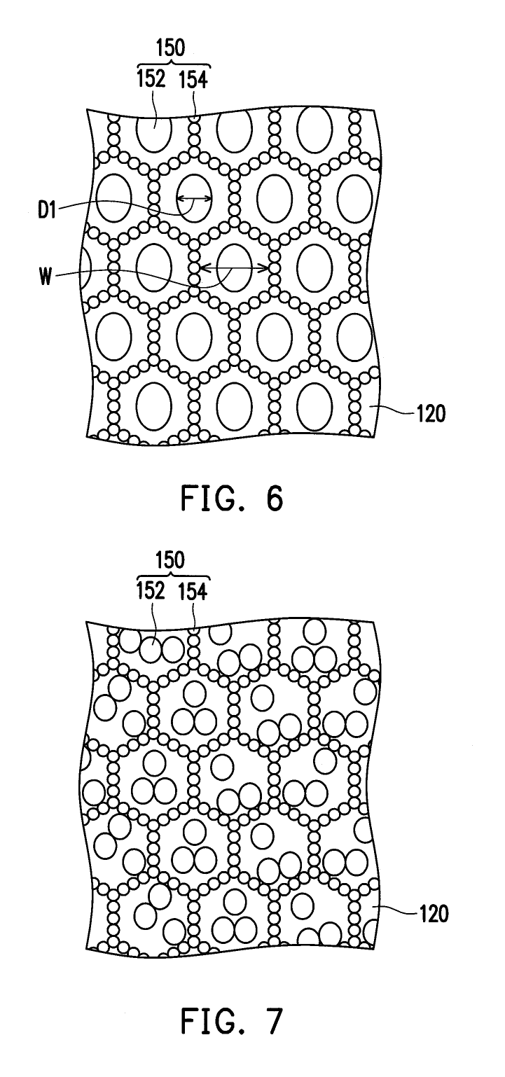

The second spacers 154 can form a plurality of patterns on the second substrate 120 and the patterns can be arranged regularly or irregularly. The arrangement of the second spacers is exemplarily described in FIG. 6 through FIG. 9. FIG. 6 through FIG. 9 schematically show the arrangement of the second spacers on the second substrate.

Referring to FIG. 6, the second spacers 154 can form a plurality of patterns regularly arranged on the second substrate 120. In the present embodiment, the patterns can form a honeycomb shape. In other embodiments, the patterns can form star shapes, trapezoid shapes, triangle shapes, rectangle shapes, circle shapes, chessboard, or other shapes. It is noted that the second spacer 154 is not restricted to be arranged to form the above patterns which can be modified according to the design requirements.

In addition, the patterns formed by arranging the second spacers 154 can selectively surround at least one first spacer 152. In the present embodiment, each pattern arranged by the second spacers 154 can just surround one first spacer 152, wherein the width W of the pattern surrounded by the second spacers 154 can be 180 μm when the diameter D1 of the first spacer 152, for example, is smaller than or equal to 100 μm. The width W of the pattern surrounded by the second spacers 154 is not particularly restricted in the invention, but the width W influences on the moving distance of the movable first spacers 152 so that the value of the width W is exemplarily pointed out. It is noted that the second spacers 154 can restrict the moving distance of the first spacers 152 in the touch panel 100 so that the rebounding rate of the first spacer 152 is improved.

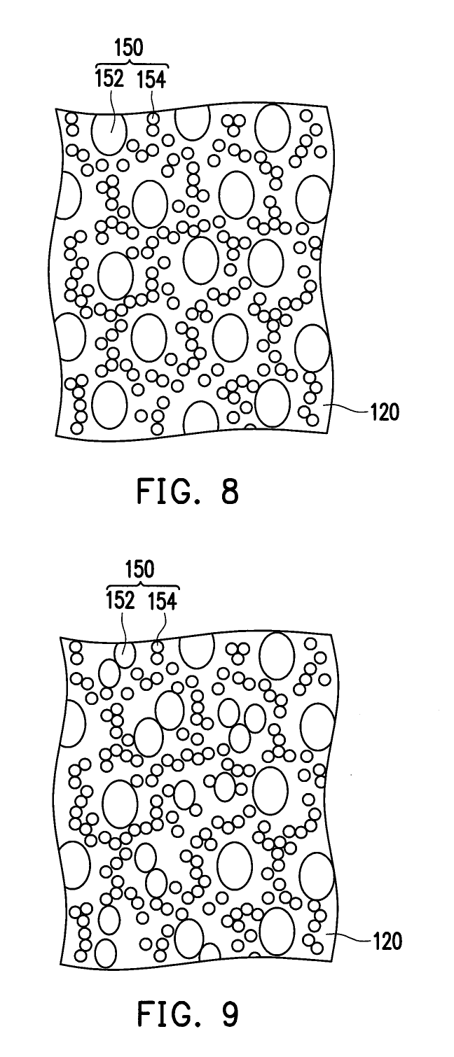

In addition to the previous embodiment having the design that the pattern formed by the second spacers 154 surrounds one first spacer 152, the pattern formed by the second spacers 154 can surround three first spacers 152 as shown in FIG. 7. It is noted that the pattern formed by the second spacers 154 can optionally surround two, four, or more first spacers 152. Furthermore, the second spacers 154 can be irregularly arranged on the second substrate 120 rather regularly arranged on the second substrate 120 in other embodiments. Referring to FIG. 8, the pattern formed by the second spacers 154 surrounds one first spacer 152 and the pattern formed by the second spacer 154 has no particular shape.

The amount of the first spacers 152 surrounded by the pattern form by the second spacers 154 and the diameter D1 of the first spacers 152 are not particularly limited in the invention. However, the distribution of the first spacers 152 with different diameters D1 is required to be even in the second substrate 120 and the moving distance of the first spacers 152 need to be restricted by the second spacers 154 fixed on the second substrate 120. Accordingly, the rebounding distance of the first spacers 152 can be reduced when the touch object is separated from the touch panel so as to improve the rebounding rate of the first spacers 152 and enhance the sensitivity of the touch panel performing the touch function capable of sensing the pressing operation of the touch object. Therefore, as shown in FIG. 9, the pattern surrounded by the second spacers 154 can have non-predetermined shape and the amount of the first spacers within the pattern surrounded by the second spacers 154 is not limited to be constant.

Based on the above embodiments, the rebounding rates in different regions of the touch panel can be variant by modifying the configuration of the spacers according to the design.

In light of the foregoing, the restoring rate of the first substrate in the touch panel according to the invention can be improved by the configuration of the spacers. By restricting the moving distance of the first spacers 152 through the second spacers 154, the rebounding distance of the first spacers 152 is reduced, thereby the time extend of the touch signal and the erroneous detection owing that the substrate is not easily restored to the original planar state are prevented and the touch sensitivity of the touch panel can be enhanced.

It will be apparent to those skilled in the art that various modifications and variations can be made to the structure of the present invention without departing from the scope or spirit of the invention. In view of the foregoing, it is intended that the present invention cover modifications and variations of this invention provided they fall within the scope of the following claims and their equivalents.

What is claimed is:

1. A touch panel, comprising:
a first substrate;
a second substrate parallel to and opposite to the first substrate in a top-bottom manner;
a first sensing layer disposed on the first substrate and located between the first substrate and the second substrate;
a second sensing layer disposed on the second substrate; and
a plurality of spacers located between the first sensing layer and the second sensing layer, and the spacers comprising a plurality of movable first spacers and a plurality of second spacers fixed on the second substrate, wherein each of the first spacers is surrounded by a portion of the second spacers.

2. The touch panel as claimed in claim 1, wherein a moving distance of the each of the first spacers is not greater than a diameter of the each of the first spacers.

3. The touch panel as claimed in claim 1, wherein at least one of the first spacers leans between the first substrate and the second substrate.

4. The touch panel as claimed in claim 1, wherein diameters of the first spacers are greater than diameters of the second spacers.

5. The touch panel as claimed in claim 1, wherein the second spacers form a plurality of patterns regularly arranged.

6. The touch panel as claimed in claim 1, further comprising a medium filled between the first substrate and the second substrate.

7. The touch panel as claimed in claim 1, further comprising a sealant and at least one third spacer, the sealant connecting the first substrate and the second substrate together, the at least one third spacer being disposed inside the sealant and leant between the first substrate and the second substrate, wherein diameters of the first spacers are not greater than a diameter of the at least one third spacer.

8. The touch panel as claimed in claim 1, further comprising a decoration layer located at a periphery of the first sensing layer.

9. The touch panel as claimed in claim 1, wherein the first sensing layer is a single-layered sensing electrode.

10. The touch panel as claimed in claim 1, wherein the second sensing layer is disposed between the first substrate and the second substrate.

11. The touch panel as claimed in claim 1, wherein the second sensing layer is located at a side of the second substrate away from the first substrate.
